(19) United States
(12) Patent Application Publication
(10) Pub. No.: US 2018/0031110 A1
(43) Pub. Date: Feb. 1, 2018

(54) IRRIGATION SYSTEM WITH GEARBOX HEAT EXCHANGERS

(71) Applicant: LINDSAY CORPORATION, Omaha, NE (US)

(72) Inventors: Kurt Ivan Cook, Omaha, NE (US); Richard Edward Provaznik, Omaha, NE (US)

(73) Assignee: LINDSAY CORPORATION, Omaha, NE (US)

(21) Appl. No.: 15/223,152

(22) Filed: Jul. 29, 2016

(51) Int. Cl. F16H 57/04; F28D 1/047; F28D 1/02; A01G 25/09; F28F 27/02

(52) U.S. Cl. CPC F16H 57/0413; F16H 57/0417; F16H 57/0498; A01G 25/09; F28F 27/02; F28D 1/0213; F28D 1/0477; F28D 2021/004

(57) ABSTRACT

An irrigation system having mobile towers interconnected by spans, a plurality of fluid conduits supported on or formed through the spans and connectable to a source of water, and a drive system for actuating movement or travel of the spans or towers. The fluid conduits may include orifices or sprinkler heads for dispersing water onto a field. The drive system may include a gearbox with gears and lubricant therein. The irrigation system may also include heat exchanger conduits fluidly coupled at one or both ends with the fluid conduits and extending through one or more of the gearboxes, such that irrigation fluid flowing through the heat exchanger conduit from the fluid conduits cools the temperature of the lubricant therein, thus cooling components of the drive system. The irrigation system may also include thermostat-controlled valves for allowing water into the heat exchanger conduits once a threshold temperature is reached.

### BACKGROUND

Irrigation systems are frequently used to deposit water, pesticides, and/or other fluids throughout a field of crops. A typical irrigation system includes multiple spans linked together and moved through the field on frame pieces or “mobile towers” having wheels. A center-pivot irrigation system moves in a circle or semi-circle about a center-pivot while a lateral-move irrigation system moves along a generally straight line across a generally-square or rectangular-shaped field.

The spans may include and/or support conduits through which irrigation fluids such as water or other liquids may flow and be dispensed onto the field of crops. These conduits may have holes through which the irrigation fluid is dispensed and/or sprinkler heads or other known water dispensing mechanisms fluidly coupled therewith.

Irrigation systems also generally have one or more drive systems with motors for actuating travel of the towers and/or spans. These drive systems can get hot during operation, due to motor heat or environmental factors. This heat may damage or degrade some components of the drive systems over time and reduce the efficiency of the irrigation system. Heat can also negatively affect the viscosity of lubricants used it gearboxes of these drive systems.

### SUMMARY

Embodiments of the present invention solve the above described problems by providing an irrigation system that uses irrigation fluid to cool its drive system components. An embodiment of the irrigation system includes a plurality of fluid conduits moveable across a field and connectable to a source of irrigation fluid, a drive system for actuating movement of the fluid conduits over the field, and a heat exchanger conduit fluidly coupled at one or both ends with the fluid conduits. The fluid conduits may have one or more orifices formed therethough for dispersing of irrigation fluid therefrom. The drive system may include at least one chamber having oil, lubricant, or hydraulic fluid therein, and the heat exchanger conduit may extend through the chamber of the drive system. Irrigation fluid flowing through the fluid conduits may thus flow through the heat exchanger conduit and cool the oil, lubricant, or hydraulic fluid therein. This may also cool one or more components of the drive system.

In another embodiment of the invention, an irrigation system may include moveable towers spaced apart from each other, spans extending between and supported by the movable towers, fluid conduits supported on or formed through the spans and connectable to a source of irrigation fluid, a drive system for actuating movement or travel of the spans or towers, and one or more heat exchanger conduits. The fluid conduits may have one or more orifices formed therethough for dispersing of irrigation fluid therefrom. The drive system may include at least one chamber having oil, lubricant, or hydraulic fluid therein. The heat exchanger conduits may be fluidly coupled at one or both ends with the fluid conduits and may extend through the chamber or chambers of the drive system, such that irrigation fluid flowing through the heat exchanger conduit from the fluid conduits cools the temperature of the oil, lubricant, or hydraulic fluid therein, thus cooling one or more components of the drive system.

In yet another embodiment of the invention, an irrigation system may include moveable towers spaced apart from each other, spans extending between and supported by the movable towers, fluid conduits supported on or formed through the spans and connectable to a source of irrigation fluid, a drive system for actuating movement or travel of the spans or towers, and one or more heat exchanger conduits. The fluid conduits may have one or more orifices formed therethough for dispersing of irrigation fluid therefrom. The drive system may include at least one gearbox housing one or more gears and oil, lubricant, or hydraulic fluid therein. The heat exchanger conduit may be fluidly coupled at one or both ends with at least one of the fluid conduits and may extend through the gearbox or multiple gearboxes of the drive system, such that irrigation fluid flowing through the heat exchanger conduit from the fluid conduits cools the temperature of the oil, lubricant, or hydraulic fluid therein, thus cooling one or more components of the drive system. The irrigation system may also include a thermostat that measures a temperature of the oil, lubricant, or hydraulic fluid, and a valve controlled by the thermostat, such that fluid is diverted from the fluid conduits into the heat exchanger conduit when the thermostat reaches or exceeds a predetermined threshold temperature.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an irrigation system constructed in accordance with an embodiment of the invention, gearboxes through which heat exchanger conduits extend;

FIG. 2 is a perspective view of a tower and span of the irrigation system of FIG. 1, illustrating heat exchanger conduits fluidly coupled with fluid conduits of the irrigation system and extending through the gearboxes thereof;

FIG. 3 is a perspective view of the tower and span of FIG. 2 with tires/wheels removed to illustrate wheel gearboxes of the tower;

FIG. 4 is a fragmentary view of a top section of the tower and span of FIG. 2, illustrating fluid control mechanisms such as a valve and a pump for selectively controlling the flow of irrigation water into the heat exchanger conduits;

FIG. 5 is a fragmentary view of the bottom section of the tower of FIG. 2, illustrating the wheel gearboxes and a center drive motor gearbox with heat exchanger conduits extending therethrough;

FIG. 6 is a perspective view of the center drive motor gearbox of FIG. 5;

FIG. 7 is a cross-sectional perspective view of the center drive motor gearbox of FIG. 6;

FIG. 8 is a cross-sectional elevation view of the center drive motor gearbox of FIG. 6, illustrating a lubricant line up to which lubricant or oil is filled within the center drive motor gearbox;

FIG. 9 is a perspective view of one of the wheel gearboxes of FIG. 5;

FIG. 10 is a cross-sectional perspective view of the wheel gearbox of FIG. 9;

FIG. 11 is a cross-sectional elevation view of the wheel gearbox of FIG. 9, illustrating a lubricant line up to which lubricant or oil is filled within the wheel gearbox; and

FIG. 12 is a schematic block diagram of a sensor or thermostat in one of the drive system components or gearboxes being communicably coupled with the fluid control mechanisms of FIG. 4.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

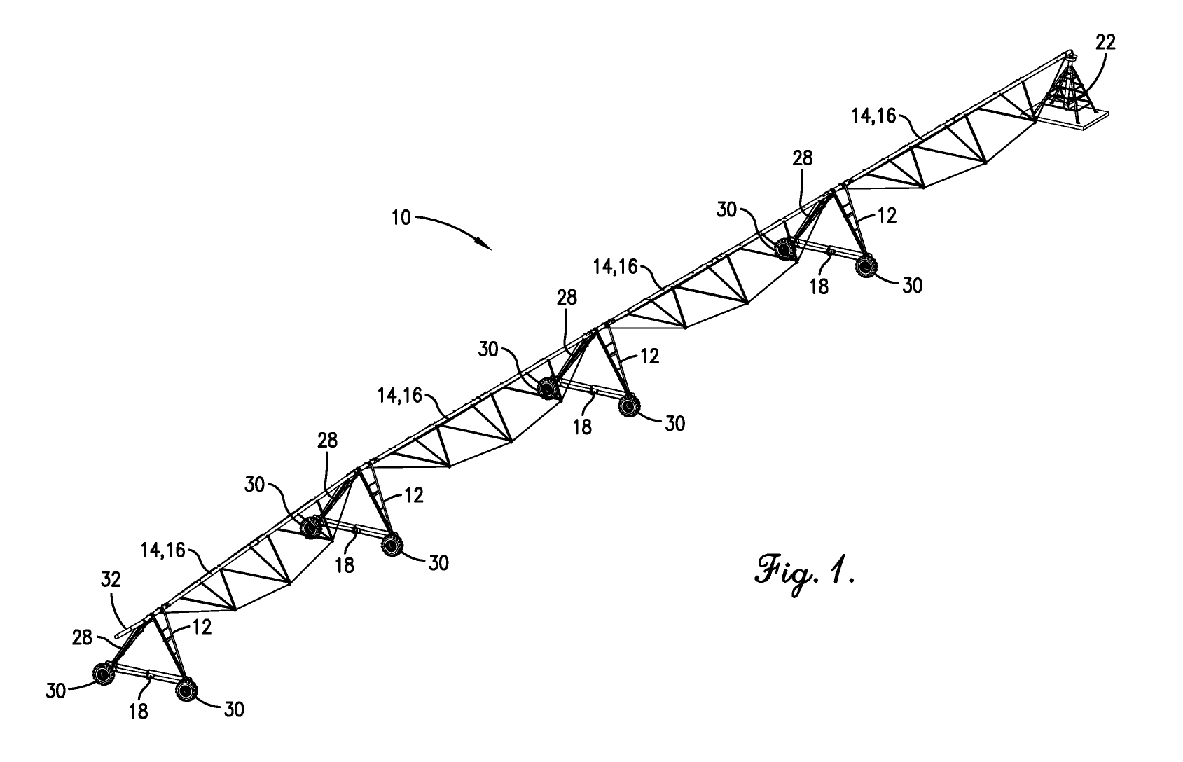

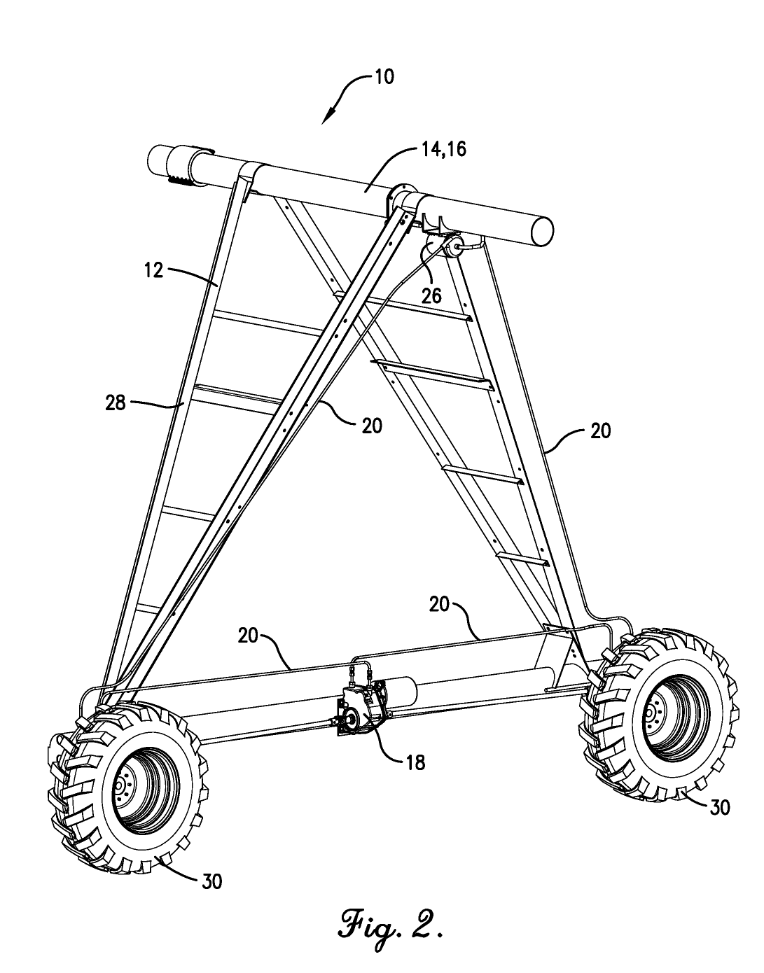

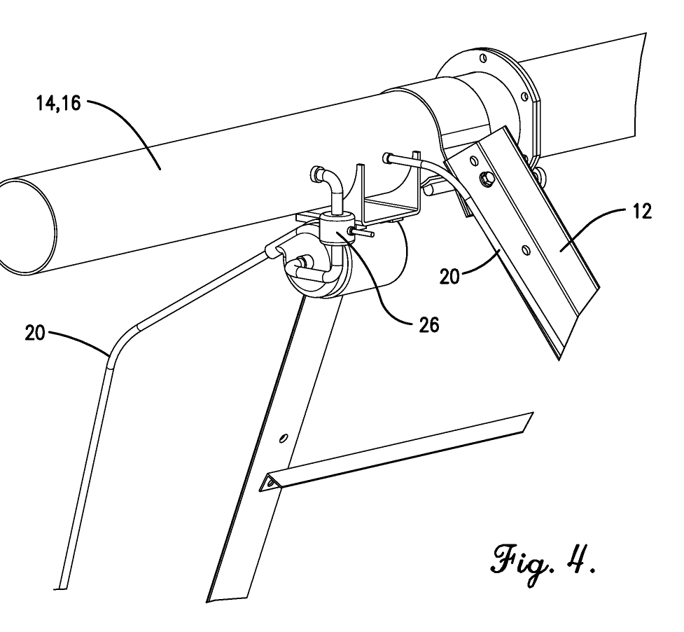

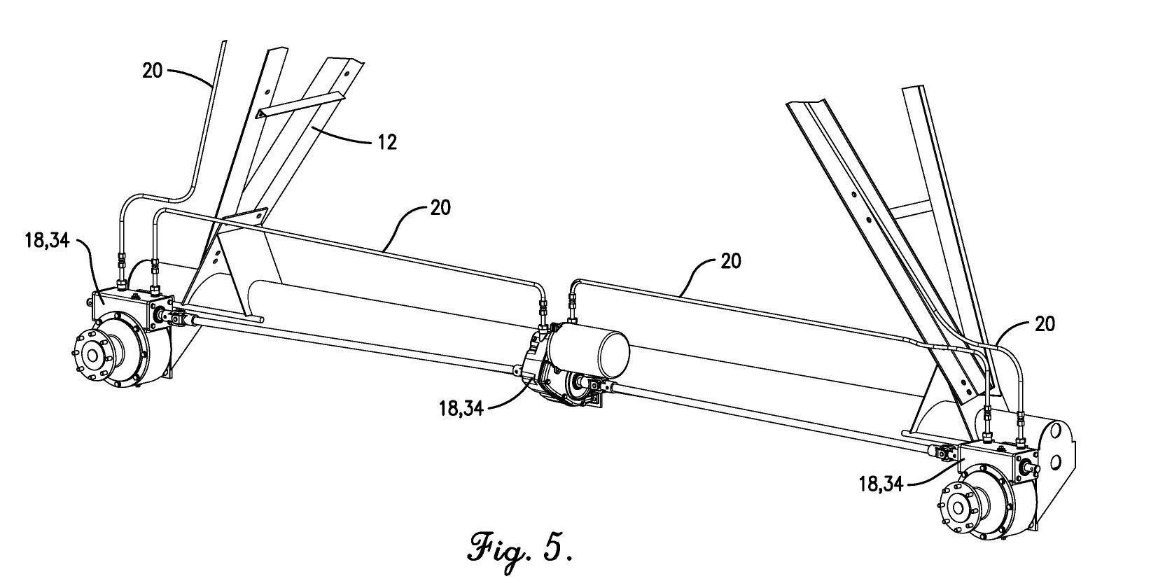

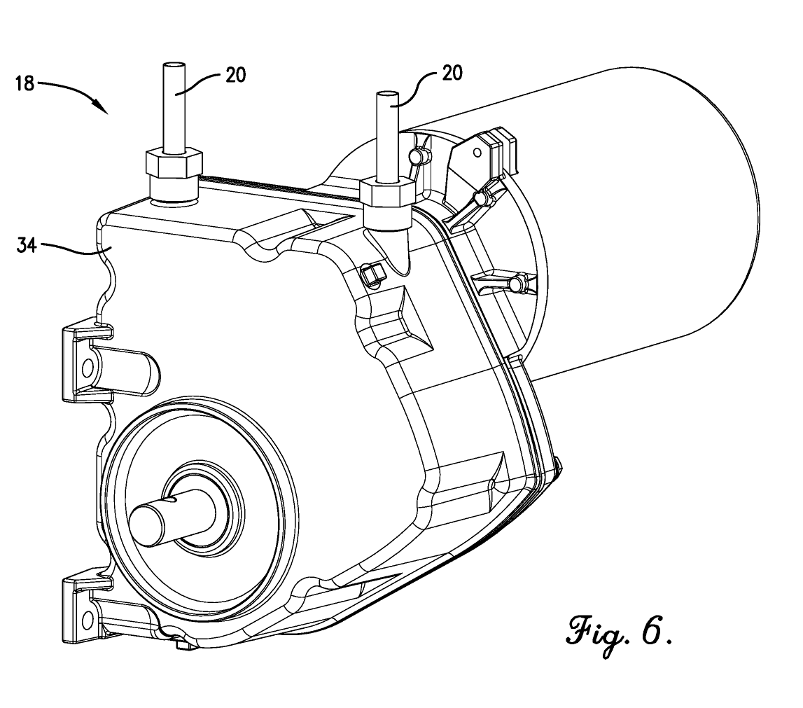

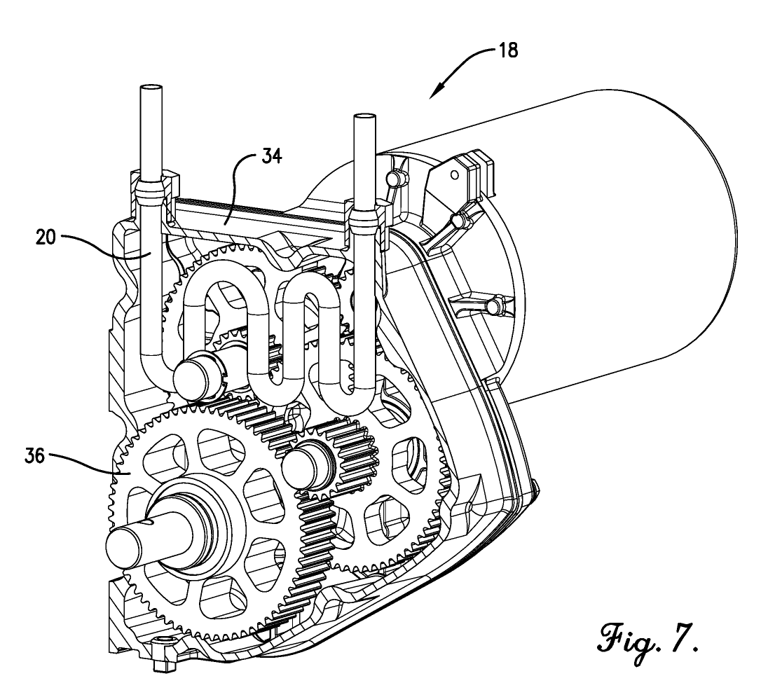

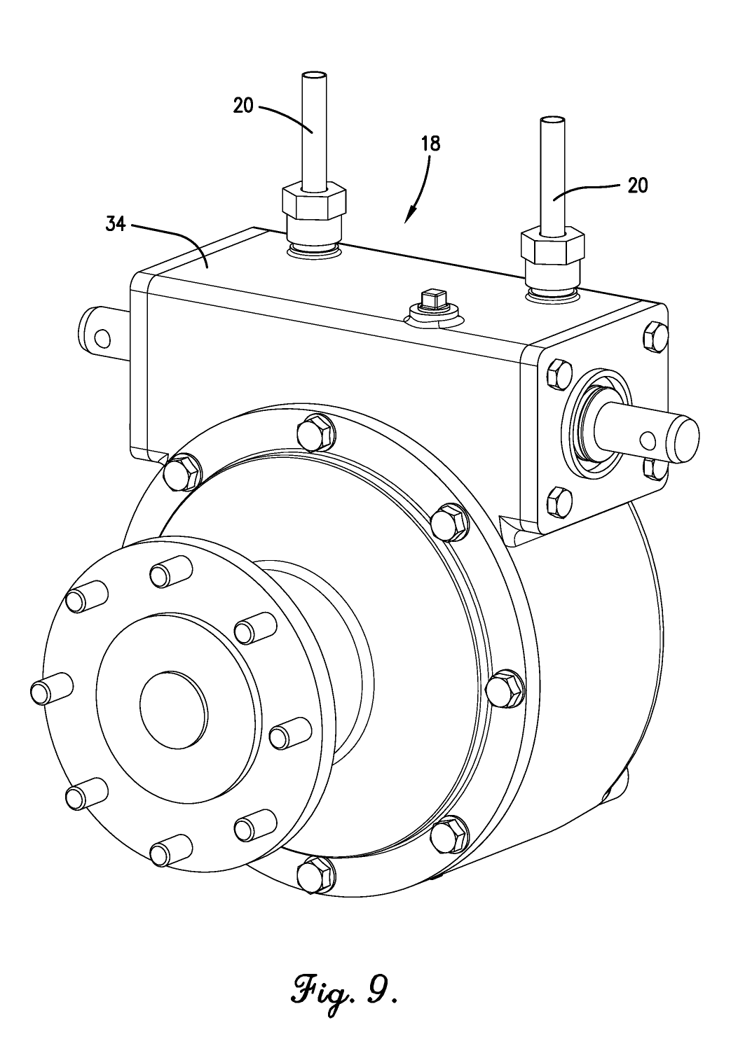

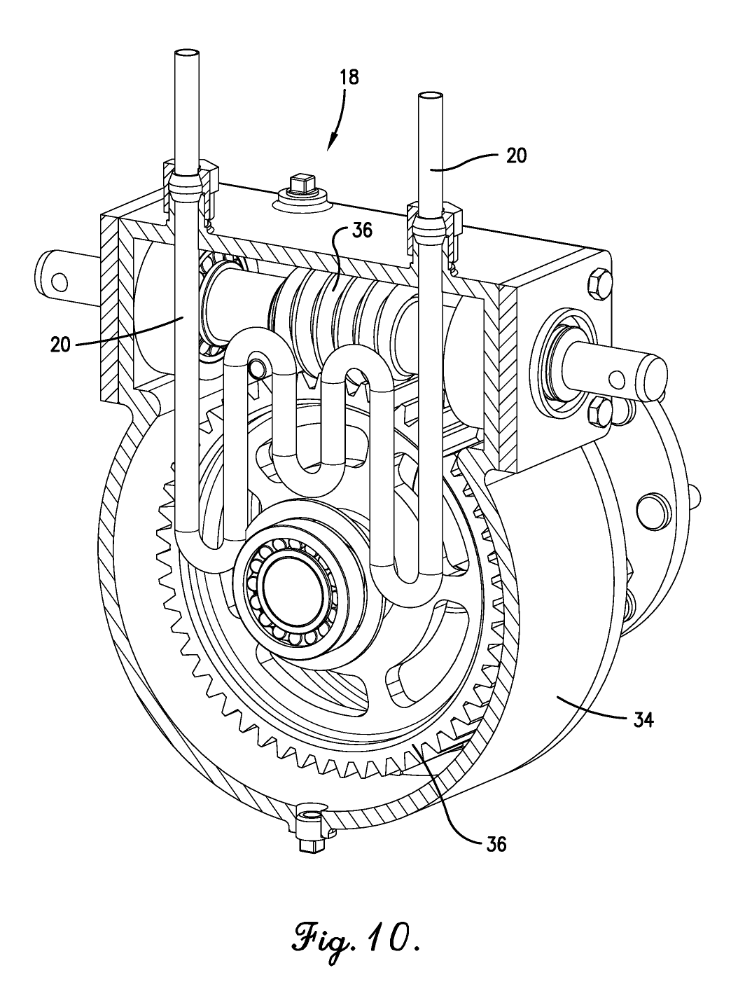

An irrigation system 10 constructed in accordance with an embodiment of the invention and configured for irrigating a field is illustrated in FIG. 1. The irrigation system 10 broadly comprises a plurality of spaced mobile towers 12, a plurality of spans 14 extending between and supported by the mobile towers 12, one or more fluid conduits 16 through which water or other fluids are delivered to the field, one or more drive systems 18 for driving the mobile towers 12 through the field, and one or more heat exchanger conduits 20, as illustrated in FIGS. 2-11, that divert a portion of the fluid flowing through the fluid conduits 16 to and/or through one or more components of the drive systems 18. The irrigation system 10 may be a center-pivot irrigation system having a fixed center pivot 22 or fixed center mobile tower, which serves as a center point about which the other mobile towers 12 and spans 14 rotate or circumscribe completely or partially. Alternatively, the irrigation system 10 may be a lateral-move irrigation system or the like. In some embodiments of the invention, as illustrated in FIGS. 2-4 and 12, the irrigation system 10 may further comprise sensors 24 or thermostats associated with the drive systems 18 and a plurality of fluid control mechanisms 26 configured to alternately prevent and permit fluid to flow from the fluid conduits 16 into the heat exchanger conduits 20.

The mobile towers 12, as illustrated in FIG. 1, may each comprise a frame 28 of any shape and one or more wheels 30 rotatably attached to the frame 28. In some embodiments of the invention, the frame 28 of at least some of the mobile towers 12 may be made of one or more rods shaped in a substantially triangular or A-frame configuration having lower leg portions configured for attaching the wheels 30 thereto. Additionally or alternatively, the frame 28 of at least some of the mobile towers 12 may be made of one or more rods shaped in a substantially narrow rectangular shape with leg portions extending horizontally outward and then angled downward therefrom for attaching the wheels 30 thereto.

The mobile tower wheels 30 illustrated and described herein are merely examples of mechanisms for permitting movement of the irrigation system 10. The term “wheel” or “wheels” as used herein may refer to conventional circular wheels, skis, skids, tank tracks and wheels, rollers on a track, or any mechanism on which the mobile towers may travel relative to the ground.

The mobile towers 12 may be spaced apart from each other, and linked together via the spans 14. For example, one of the spans 14 may laterally span a distance between a first mobile tower and a second mobile tower spaced apart from each other. The mobile towers 12 may support the spans 14 a distance above the field. In some embodiments of the invention, the mobile towers 12 may carry the spans 14 along a circular or semi-circular path about the center pivot 22. The irrigation system 10 may comprise any quantity of mobile towers and spans required to cover a desired area of the field.

As illustrated in FIG. 1, the spans 14 may each be elongated structures spanning an entire distance between adjacent ones of the mobile towers 12. Each of the spans 14 may be fixedly or pivotally connected with at least one of the mobile towers 12 and/or each other. In some embodiments of the invention, the spans 14 may be elongated rigid truss structures, booms, conduits pipes, bars, extension arms, or other structures of various configurations. For example, in FIG. 1, the spans include elongated conduits with spreader bars mounted thereto and extending below the elongated conduits. However, the spans 14 may have any shapes and dimensions without departing from the scope of the invention. In some embodiments of the invention, one or more of the spans 14 may be an extension arm 32 or pivoting turret having a first end fixedly or pivotally joined with one of the mobile towers 12 and a second end not joined to the mobile towers 12 or substantially free standing.

The spans 14 may carry or otherwise support portions of the fluid conduits 16. Specifically, portions of the fluid conduits 16 may attach to and/or be supported by the spans 14, such that irrigation fluid, such as water and/or any other liquid, may be dispensed at given intervals along a length of the spans 14. A plurality of sprinkler heads, spray guns, drop nozzles, or other fluid-emitting devices may be spaced along the spans 14 and/or at one or more of the mobile towers 12 to apply water and/or other fluids delivered thereto via the fluid conduits 16 to the field or land underneath the irrigation system 10.

In some embodiments of the invention, the spans 14 may be integrated with the fluid conduits 16. For example, each of the spans 14 may comprise rigid pipes or conduits extending an entire distance between two of the mobile towers 12 and in fluid communication with a water source, such that water may flow therethrough. In this embodiment of the invention, the spans 14 may also comprise holes formed therethrough and/or inlets and outlets for dispensing irrigation fluid desired to be applied to the field.

The fluid conduits 16 may comprise one or more conduits, pipes, or hoses and may be fluidly coupled with one or more fluid-emitting devices, such as sprinkler heads, drip holes formed in the conduits, spray nozzles, or other fluid emitters. Each of the fluid-emitting devices may be fixed to one of the mobile towers 12, to the spans 14, or to any portion of the irrigation system 10. At least one of the fluid-emitting devices may comprise and/or be fluidly connected to a supply/shut-off valve for turning water on and off to the fluid-emitting devices and controlling how much water is provided to the fluid-emitting devices. The supply/shut-off valve may be actuated manually, electronically, remotely, and/or automatically via computer control systems or the like, which may be physically and/or communicably coupled with the supply/shut-off valve. The fluid conduits 16 may be hoses or pipes fluidly linking the fluid-emitting devices with a fluid supply or source. A pump or any other actuation means may be used to force water or another fluid through the fluid conduits 16 to the fluid-emitting devices. In some embodiments of the invention, the fluid conduits 16 may further comprise a drop pipe fluidly connected to the conduits to allow for a drain and flushing of fluid in the fluid conduits 16.

In some embodiments of the invention, a plurality of fluid supplies and/or supply hook-ups, such as hydrants, may be located at various locations relative to the field, and the fluid conduits 16 may be configured to attach to the nearest one of the fluid supplies. In another embodiment of the invention, the fluid supply may be a water canal or any other fluid source near the field. In some embodiments of the invention, the irrigation system 10 may include a pump configured to pump water from a canal through the fluid conduits 16.

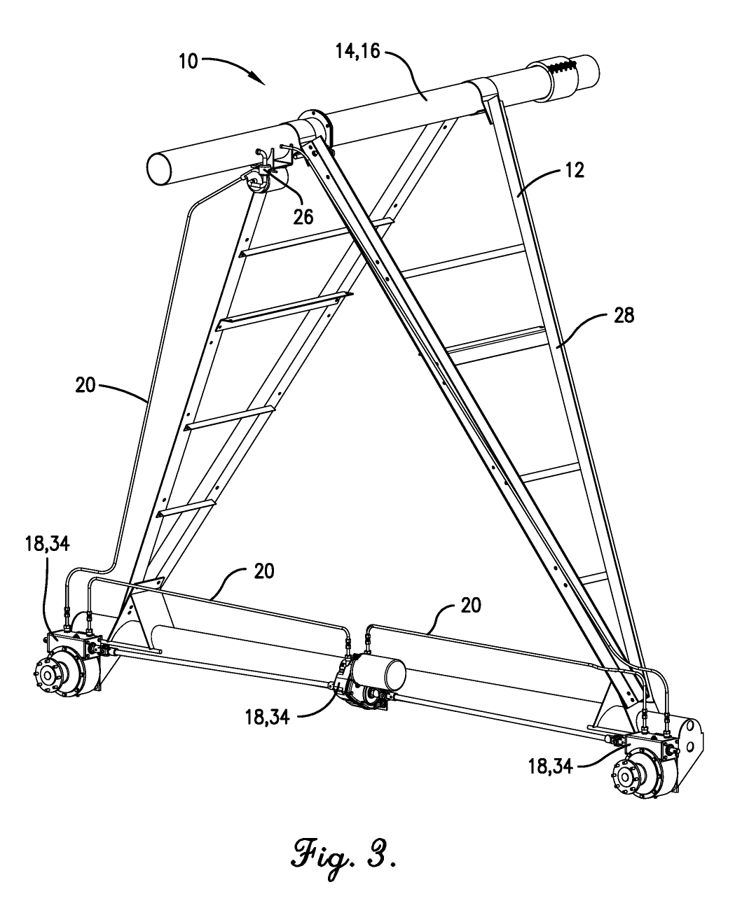

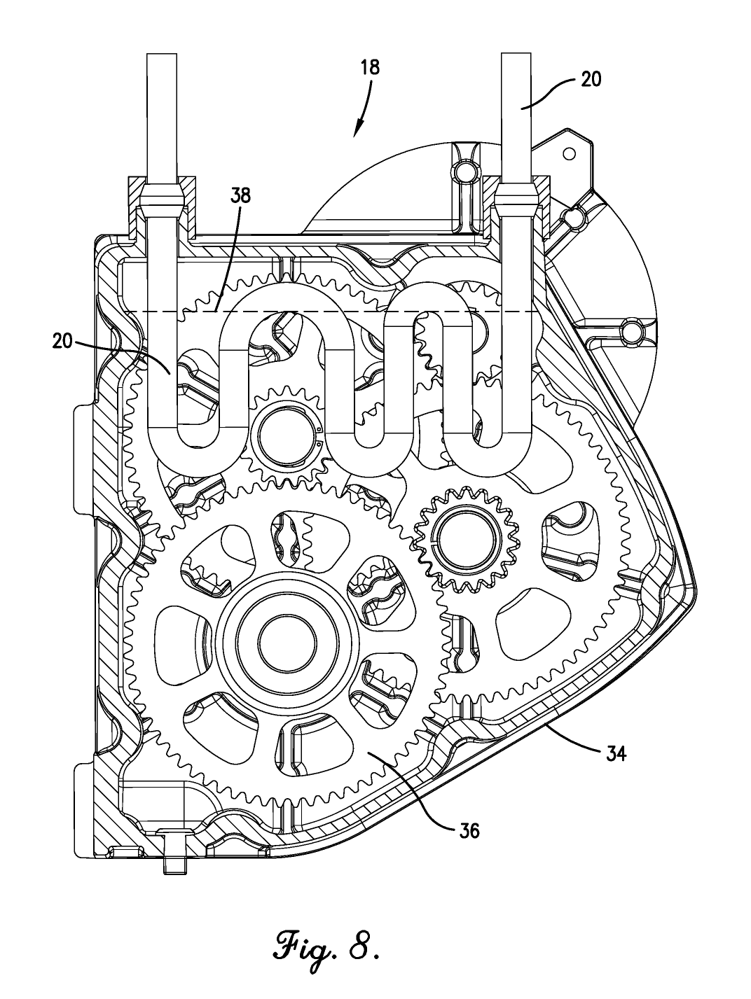

The drive systems 18 may include drive motors and mechanisms known in the art for driving towers of an irrigation system through a field. In some embodiments of the invention, the drive systems 18 may comprise a wheel gearbox (as illustrated in FIGS. 3, 5, and 9-11), a center drive motor gearbox (as illustrated in FIGS. 1-3 and 5-8), and/or a variable speed drive, such as a variable frequency drive (VFD). The drive systems 18 may include one or more chambers 34, such as gearboxes, surrounding one or more gears 36, such as rotary gears or other such gears known in the art. For example, the gears 36 in the chambers 34 or gearboxes may comprise a worm gear and/or a bull gear. However, other moveable mechanical components may be housed within the chambers 34 without departing from the scope of the invention. The chambers 34 or gearboxes may further be at least partially filled with an oil, lubricant, or hydraulic fluid, designed to prevent friction between various mechanical components and gears within the gearboxes. A lubricant fill line 38 is illustrated in FIGS. 8 and 11, for example, showing one of the heat exchanger conduits 20 extending below this fill line. In some embodiments of the invention, the drive systems 18 may further comprise hydraulic pumps and motors having hydraulic fluid flowing therethrough.

The drive systems 18 may be independently or cooperatively actuatable to drive the wheels 30 and thus drive the mobile towers 12 through the field and/or rotatably about the center pivot 22. Specifically, one or more motors (not shown) may drive gears or transmission components in the chambers 34, which may in turn drive the wheels 30 of the mobile towers 12. The motors or transmissions of the drive systems 18 may further be coupled with a drive shaft, gears, belts, chains, sprockets, etc. to rotatably couple the motors and/or the transmissions with the wheels 30.

As illustrated in FIGS. 2-11, the heat exchanger conduits 20 may include any fluid conduits, pipes, or hoses known in the art and may extend at least partially into or through components of the drive systems 18. For example, the heat exchanger conduits 20 may extend through a gearbox (e.g., below the fill line 38 in FIGS. 8 and 11), with an outer surface thereof contacting the lubricant within the gearbox or chamber 34. Additionally or alternatively, the heat exchanger conduits 20 may extend through a center of the worm gear or the like within the gearbox. In some embodiments of the invention, the heat exchanger conduits 20 may extend through a chamber of a hydraulic pump or motor, such than an outer surface of the heat exchanger conduits 20 contacts the hydraulic fluid therein, for cooling thereof.

The heat exchanger conduits 20 may be made of a material sufficiently thermally conductive for optimal heat transfer between the lubricant and the irrigation fluid flowing through the heat exchanger conduits 20. EXAMPLES OF MATERIAL TO BE USED FOR THESE CONDUITS? As illustrated in FIGS. 2-11, the heat exchanger conduits 20 may be continually and/or selectively fluidly coupled with the fluid conduits 16 via the fluid control mechanisms 26, as described below, or via any other fluid port or outlet of the fluid conduits 16. In some embodiments of the invention, the heat exchanger conduits 20 may snake back and forth a plurality of times within the chamber 34 or gearbox. However, the heat exchanger conduits 20 may follow any path within the gearboxes without departing from the scope of the invention.

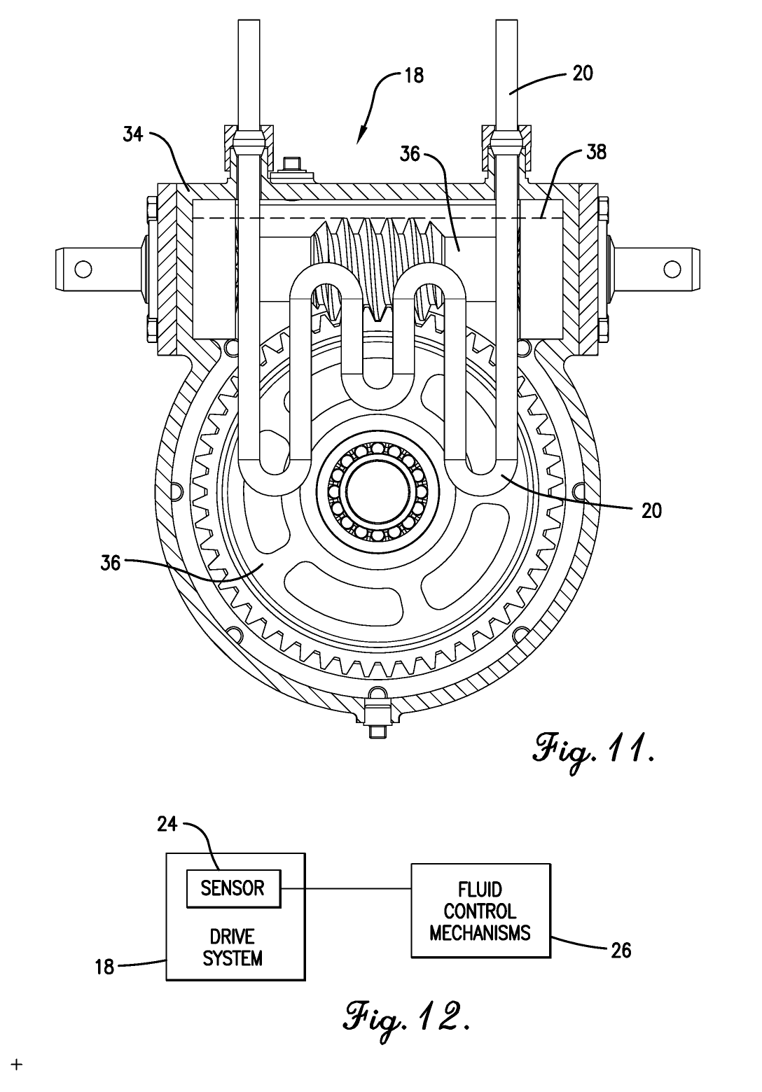

The sensors 24, as schematicially illustrated in FIG. 12, may be temperature sensors such as thermostats which measure physical characteristics of one or more of the drive systems 18, such as a temperature of the lubricant in the chamber 34 or gearbox. The sensors 24 or thermostats may be communicably coupled with the fluid control mechanisms 26. For example, any one of the thermostats may output a control signal to open a valve of the fluid control mechanisms 26 at a predetermined lubricant temperature sensed by the thermostats.

The fluid control mechanisms 26, as illustrated in FIGS. 2-4, may merely include a flow divider, splitting a water or fluid between the fluid conduits 16 and the heat exchanger conduits 20. Additionally or alternatively, the fluid control mechanisms 26 may include one or more independently actuatable pumps, valves, and/or a manifold with a plurality of independently actuatable valves. The pumps or valves may be mechanically and/or electrically controlled via signals received from the sensors 24, as illustrated in FIG. 12. For example, each of the gearboxes of the irrigation system 10 may comprise a thermostat associated with one of the valves that controls flow of fluid from the fluid conduits 16 to one of the heat exchanger conduits 20 within an associated one of the gearboxes. Thus, when a temperature within one of the gearboxes exceeds a predetermined threshold, an associated one of the valves may be opened, and the gearbox may be cooled by fluid flowing therein via one of the heat exchanger conduits 20.

In use, water or fluid used to irrigate a field may be pumped through the fluid conduits 16. All or a portion of the water or fluid may be either continually or selectively diverted through the heat exchanger conduits 20 that extend through the chambers 34 or gearboxes of the drive systems 18, thus cooling the lubricant and/or various components of the drive systems 18. For example, the fluid or water may flow freely through the fluid conduits 16, into one of the heat exchanger conduits 20, and back out to another one of the fluid conduits 16, such that fluid or water for irrigating the field continuously cools the chambers 34 or gearboxes of the drive systems 18.

In some embodiments of the invention, the fluid control mechanisms 26 may be actuated between an open configuration and a closed configuration based on control signals received from an associated one of the sensors 24. For example, once the lubricant, oil, or hydraulic fluid in one of the gearboxes rises above a predetermined threshold temperature, an associated one of the sensors 24 or thermostats may send a control signal opening up a valve associated with the heat exchanger conduit 20 within that gearbox, thus cooling that gearbox and its components therein.

Irrigation fluid or water diverted for cooling can be circulated through a closed or open loop configuration. The irrigation water can be circulated through multiple devices connected in series or through the manifold described above, which may direct parallel flows through multiple devices only as needed, when commanded by respective thermostats or other temperature sensors 24.

Reducing operating temperatures within the gearboxes or hydraulic pumps of the drive systems 18 as described herein may provide a number of advantages over prior art irrigation systems. For example, this reduction in operating temperatures may increase component life, maintain a designed viscosity of the lubricant, and extend the life of anti-wear properties of the lubricant. Furthermore, the reduced operating temperatures may prolong life and performance of lip seals on rotating shafts in the gearboxes, promoting better hydrodynamic sealing, and may discourage lubricant leaking out of the gearboxes. The invention described herein may also prevent the ingress of contaminants such as moisture, dirt, or the like from entering into the gearbox. Likewise, reducing operating temperature of hydraulic fluid in hydraulic pumps and motors may ensure longer life of anti-wear and fluid conditioning additives which extends component life and increases drive system efficiency.

Although the invention has been described with reference to the embodiments illustrated in the attached drawing figures, it is noted that equivalents may be employed and substitutions made herein without departing from the scope of the invention as recited in the claims. For example, in some alternative embodiments of the invention, heat exchanger conduits may carry irrigation water or fluid to reduce heat load on other devices in the irrigation system 10, regardless of intended purpose. For example, final drive transmissions, center drive transmissions, and the like may be cooled via heat exchanger conduits carrying irrigation water thereto as described herein.

Having thus described various embodiments of the invention, what is claimed as new and desired to be protected by Letters Patent includes the following:

1. An irrigation system comprising:
a plurality of fluid conduits moveable across a field and connectable to a source of irrigation fluid, wherein the fluid conduits have one or more orifices formed therethough for dispersing of the irrigation fluid therefrom;
a drive system for actuating movement of one or more of the fluid conduits, the drive system including at least one chamber operable to hold oil, lubricant, or hydraulic fluid therein; and
at least one heat exchanger conduit fluidly coupled at one or both ends with at least one of the fluid conduits and extending through the at least one chamber, such that at least a portion of the irrigation fluid flows through the heat exchanger conduit from the fluid conduits to cool the oil, lubricant, or hydraulic fluid therein, thus cooling one or more components of the drive system with the irrigation fluid.

2. The irrigation system of claim 1, wherein the drive system comprises a plurality of gears and the at least one chamber is a gearbox substantially surrounding the plurality of gears and having the oil, lubricant, or hydraulic fluid contained therein.

3. The irrigation system of claim 1, wherein the drive system comprises at least one of a wheel gearbox, a center drive motor gearbox, a hydraulic pump, a hydraulic motor, and a variable speed drive.

4. The irrigation system of claim 1, wherein the heat exchanger conduit is coupled in series between two of the fluid conduits, such that at least a portion of the irrigation fluid passes from one of the fluid conduits, through the heat exchanger conduit and exits to another one of the fluid conduits.

5. The irrigation system of claim 1, further comprising a thermostat that measures a temperature of the oil, lubricant, or hydraulic fluid and a valve controlled by the thermostat, such that irrigation fluid is diverted from the fluid conduits into the heat exchanger conduit if the thermostat reaches or exceeds a predetermined threshold temperature.

6. The irrigation system of claim 1, wherein the at least one heat exchanger conduit comprises a plurality of heat exchanger conduits and the drive system comprises a plurality of gearboxes each having a thermostat therein measuring a temperature of the oil, lubricant, or hydraulic fluid in the gearboxes, wherein each of the heat exchanger conduits extend through one of the gearboxes, wherein the irrigation system further comprises a manifold having a plurality of manifold valves coupling the fluid conduits with the plurality of heat exchanger conduits, wherein each of the manifold valves are controlled by one of the thermostats.

7. The irrigation system of claim 1, wherein the drive system comprises a worm gear, wherein the heat exchanger conduit extends through a center of the worm gear.

8. An irrigation system comprising:
a plurality of moveable towers spaced apart from each other;
a plurality of spans extending between and supported by the movable towers;
a plurality of fluid conduits supported on or formed through the spans and connectable to a source of irrigation fluid, wherein the fluid conduits have one or more orifices formed therethough for dispersing of the irrigation fluid therefrom;
a drive system for actuating movement or travel of at least one of the spans or towers, the drive system including at least one chamber operable to hold oil, lubricant, or hydraulic fluid therein; and
at least one heat exchanger conduit fluidly coupled at one or both ends with at least one of the fluid conduits and extending through the at least one chamber, such that the irrigation fluid flowing through the heat exchanger conduit from the fluid conduits cools the temperature of the oil, lubricant, or hydraulic fluid therein, thus cooling one or more components of the drive system.

9. The irrigation system of claim 8, wherein the drive system comprises a plurality of gears and the at least one chamber is a gearbox substantially surrounding the plurality of gears and having the oil, lubricant, or hydraulic fluid contained therein.

10. The irrigation system of claim 8, wherein the drive system comprises at least one of a wheel gearbox, a center drive motor gearbox, and a variable speed drive.

11. The irrigation system of claim 8, wherein the heat exchanger conduit is coupled in series between two of the fluid conduits, such that the irrigation fluid passes from one of the fluid conduits, through the heat exchanger conduit and exits to another one of the fluid conduits.

12. The irrigation system of claim 8, wherein the heat exchanger conduit snakes back and forth a plurality of times within the at least one chamber.

13. The irrigation system of claim 8, further comprising a flow divider fluidly coupling at least one of the fluid conduits with the heat exchanger conduit.

14. The irrigation system of claim 8, further comprising a thermostat that measures a temperature of the oil, lubricant, or hydraulic fluid and a valve controlled by the thermostat, such that fluid is diverted from the fluid conduits into the heat exchanger conduit if the thermostat reaches or exceeds a predetermined threshold temperature.

15. The irrigation system of claim 8, wherein the at least one heat exchanger conduit comprises a plurality of heat exchanger conduits and the drive system comprises a plurality of gearboxes each having a thermostat therein measuring a temperature of the oil, lubricant, or hydraulic fluid in the gearboxes, wherein each of the heat exchanger conduits extend through one of the gearboxes, wherein the irrigation system further comprises a manifold having a plurality of manifold valves coupling the fluid conduits with the plurality of heat exchanger conduits, wherein each of the manifold valves are controlled by one of the thermostats.

16. The irrigation system of claim 8, wherein the drive system comprises a worm gear, wherein the heat exchanger conduit extends through a center of the worm gear.

17. An irrigation system comprising:
a plurality of moveable towers spaced apart from each other;
a plurality of spans extending between and supported by the movable towers;
a plurality of fluid conduits supported on or formed through the spans and connectable to a source of water, wherein the fluid conduits have one or more orifices formed therethough for dispersing of water therefrom;
a drive system for actuating movement or travel of the spans or towers, the drive system including at least one gearbox housing one or more gears and oil, lubricant, or hydraulic fluid therein;
a heat exchanger conduit fluidly coupled at one or both ends with at least one of the fluid conduits and extending through the at least one gearbox, such that water flowing through the heat exchanger conduit from the fluid conduits cools the temperature of the oil, lubricant, or hydraulic fluid therein, thus cooling one or more components of the drive system;
a thermostat that measures a temperature of the oil, lubricant, or hydraulic fluid; and
a valve controlled by the thermostat, such that fluid is diverted from the fluid conduits into the heat exchanger conduit when the thermostat reaches or exceeds a predetermined threshold temperature.

18. The irrigation system of claim 17, wherein the drive system comprises at least one of a wheel gearbox, a center drive motor gearbox, and a variable speed drive.

19. The irrigation system of claim 17, wherein the heat exchanger conduit is coupled in series between two of the fluid conduits, such that water passes from one of the fluid conduits, through the heat exchanger conduit and exits to another one of the fluid conduits.

20. The irrigation system of claim 17, wherein the drive system comprises a worm gear, wherein the heat exchanger conduit extends through a center of the worm gear.
